(19) United States
(12) Patent Application Publication
(10) Pub. No.: US 2025/0065156 A1
(43) Pub. Date: Feb. 27, 2025

(54) MULTI-PURPOSE WEDGE TOOL

(71) Applicant: Gregory Rizos, Denville, NJ (US)

(72) Inventor: Gregory Rizos, Denville, NJ (US)

(21) Appl. No.: 18/809,456

(22) Filed: Aug. 20, 2024

Related U.S. Application Data
(60) Provisional application No. 63/520,780, filed on Aug. 21, 2023.

(51) Int. Cl. A62B 3/00; B25B 13/50; E05C 19/18

(52) U.S. Cl. CPC A62B 3/005; B25B 13/50; E05C 19/18

(57) ABSTRACT

A multi-purpose wedge tool may include a body having a wedge surface, a first base surface, a second base surface, and a sidewall surface that may be coupled together in a triangular prism shape, such as to form a wedge. The first base surface and second base surface may be generally parallel to each other and may be separated by a body recess that may be depressed into the body. A body projection may extend over a portion of the body recess, and the body projection and body recess may allow the tool to function as a spanner wrench for gripping and turning objects, such as the lugs of hose couplings by applying a moment to the lug of the coupling. The body may include one or more body apertures that may be sized and shaped to receive portions of valves or fittings that are typically manipulated by their rotation.

### CROSS REFERENCE TO RELATED APPLICATIONS

This application claims priority to and the benefit of the filing date of U.S. Provisional Application No. 63/520,780, filed on Aug. 21, 2023, entitled “MULTI-PURPOSE WEDGE TOOL”, which is hereby incorporated by reference in its entirety.

### FIELD OF THE INVENTION

This patent specification relates to the field of tools used by individuals such as firefighters and other first responders in the course of their service. More specifically, this patent specification relates to a wedge-shaped tool with multiple functions that are especially pertinent to firefighters and first responders.

### BACKGROUND

Firefighters, in the course of performing their job, have a need for a variety of tools. One such tool is a wooden wedge, typically carried in a band on their helmet, used to chock a door open as they advance through with a hose, or to chock a door open for ventilation. These wedges, being made of wood, are light enough to carry on their helmet so they are always accessible, even while wearing thick gloves, however they perform no other tasks, such as manipulating valve or hose couplings, do not stack reliably, and are not fire resistant. There are wedges in the art that are made from composite materials, but are not fireproof. Other metal wedges in the art perform additional functions but are too heavy to be carried on a helmet where they would be easily accessible.

Firefighters separately carry wrenches to operate gas and water valves, forcible entry chocks to help force a door open while making entry into a structure or vehicle, non-ferrous wedges to use with a chainsaw to keep a cut from pinching the saw chain, and spanner wrenches to tighten and loosen hose couplings. These other tools are too heavy to be kept easily accessible, must be stored inside pockets where they are difficult to retrieve with gloved hands, and, since firefighters are frequently in situations where they cannot safely remove their gloves, a safety hazard exists.

A need therefore exists for a novel, multi-purpose tool for first responders, such as firefighters, that is fire-resistant, stackable, capable of operating valves, forcing doors, working with a chainsaw, capable of functioning as an emergency escape anchor, and operating hose couplings.

### BRIEF SUMMARY OF THE INVENTION

A multi-purpose wedge tool is provided. In some embodiments, the tool may include a body having a wedge wall, a sidewall, a recess wall, a first base wall, and a second base wall. The first base wall may be coupled to the recess wall and to the sidewall. The wedge wall may be coupled to the sidewall and to the second base wall, and the recess wall may also be coupled to the second base wall. A wedge surface may be formed on the wedge wall. A body recess, the body recess comprising a recess surface, may be formed on the recess wall, so that the recess wall and recess surface may be depressed into the body below the first base wall and the second base wall. A body projection may be coupled to the recess wall, and the body projection may extend over a portion of the body recess. Preferably, the body projection and body recess may allow the tool to function as a spanner wrench for gripping and turning objects, such as the lugs of hose couplings by applying a moment to the lug of the coupling. The body may include one or more body apertures that may be sized and shaped to receive portions of valves or fittings that are typically manipulated by their rotation. Once a valve or fitting is received in body aperture it may be manipulated by rotating or otherwise moving the tool.

Numerous objects, features and advantages of the present invention will be readily apparent to those of ordinary skill in the art. Some example objects of the present invention are listed below.

One object of the present invention is to provide a wedge-shaped tool that not only functions as a multi-tool, but also provides the ability to function as a spanner wrench and manipulate a hose coupling, thus replacing the firefighter's need for a traditional spanner wrench.

Another object is to provide a wedge-shaped tool that is lightweight enough to take the place of the wedge on a first responder's helmet, such as a firefighter's helmet, while also serving that purpose of remaining accessible to the firefighter who has gloved hands.

Another object is to provide a wedge-shaped tool that is able to function as an emergency escape anchor.

Another object is to provide a wedge-shaped tool that is able to be magnetically coupled to ferrous doors and door frames, such as during forcible entry, and other ferrous objects and surfaces.

### BRIEF DESCRIPTION OF THE DRAWINGS

Some embodiments of the present invention are illustrated as an example and are not limited by the figures of the accompanying drawings, in which like references may indicate similar elements and in which:

FIG. 1—FIG. 1 depicts a perspective view of an example of a multi-purpose wedge tool according to various embodiments described herein.

FIG. 2—FIG. 2 illustrates a side elevation view of an example of a multi-purpose wedge tool according to various embodiments described herein.

FIG. 3—FIG. 3 shows a top plan view of an example of a multi-purpose wedge tool according to various embodiments described herein.

FIG. 4—FIG. 4 depicts a rear elevation view of an example of a multi-purpose wedge tool according to various embodiments described herein.

FIG. 5—FIG. 5 illustrates a side elevation view of an example of a multi-purpose wedge tool engaged to a hose coupling according to various embodiments described herein.

FIG. 6—FIG. 6 shows a side elevation view of two examples of a multi-purpose wedge tool engaged to each other according to various embodiments described herein.

FIG. 7—FIG. 7 depicts another side elevation view of an example of a multi-purpose wedge tool receiving portions of valves or fittings that are typically manipulated by their rotation according to various embodiments described herein.

FIG. 8—FIG. 8 illustrates a side elevation view of another example of a multi-purpose wedge tool according to various embodiments described herein.

FIG. 9—FIG. 9 shows another side elevation view of another example of a multi-purpose wedge tool according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

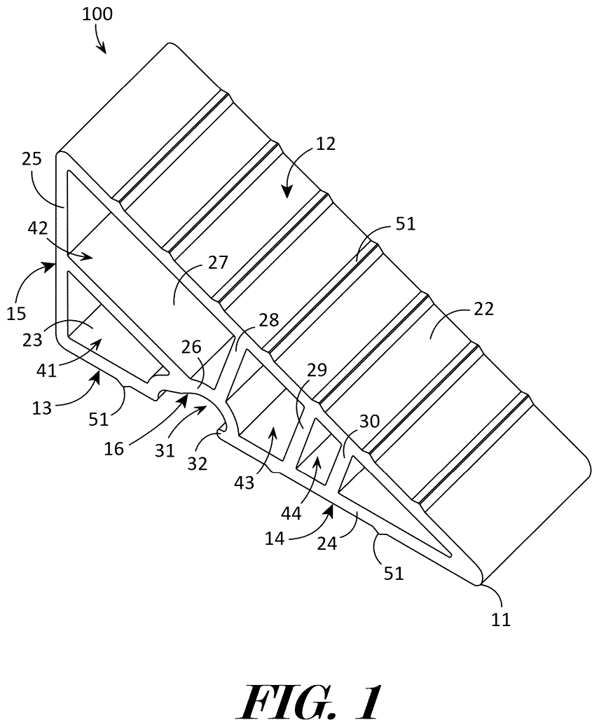

For purposes of description herein, the terms “upper,” “lower,” “left,” “right,” “rear,” “front,” “side,” “vertical,” “horizontal,” and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Although the terms “first,” “second,” etc. are used herein to describe various elements, these elements should not be limited by these terms. These terms are only used to distinguish one element from another element. For example, the first element may be designated as the second element, and the second element may be likewise designated as the first element without departing from the scope of the invention.

As used in this application, the term “about” or “approximately” refers to a range of values within plus or minus 10% of the specified number. Additionally, as used in this application, the term “substantially” means that the actual value is within about 10% of the actual desired value, particularly within about 5% of the actual desired value and especially within about 1% of the actual desired value of any variable, element or limit set forth herein.

A new multi-purpose wedge tool is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

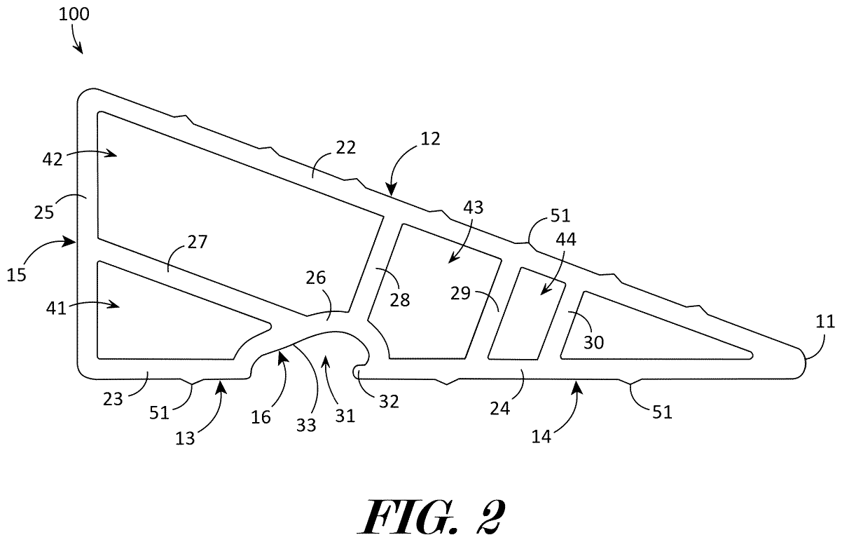

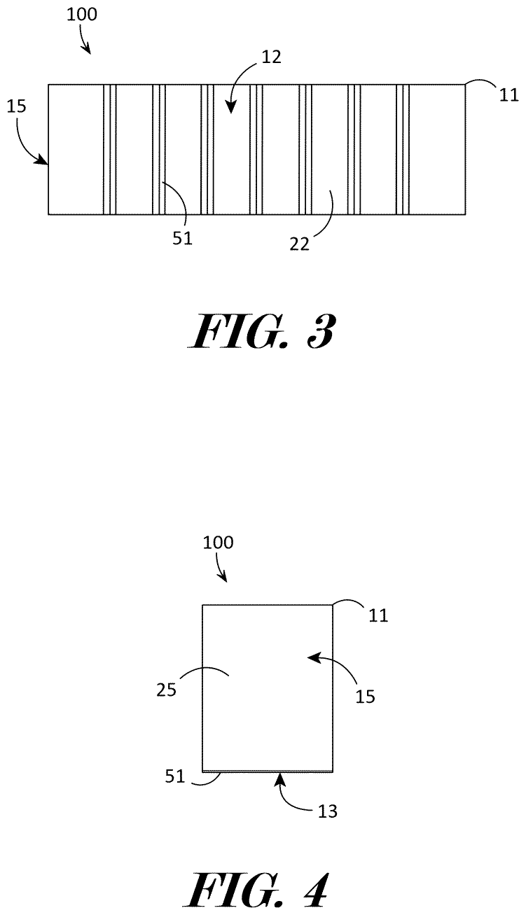

The present invention will now be described by example and through referencing the appended figures representing preferred and alternative embodiments. FIGS. 1-8 illustrate examples of a multi-purpose wedge tool (“the tool”) 100 according to various embodiments. In preferred embodiments, the tool 100 may comprise a body 11 having a wedge wall 22, a sidewall 25, a recess wall 26, a first base wall 23, and a second base wall 24. The first base wall 23 may be coupled to the recess wall 26 and to the sidewall 25. The wedge wall 22 may be coupled to the sidewall 25 and to the second base wall 24, and the recess wall 26 may also be coupled to the second base wall 24. A wedge surface 12 may be formed on the wedge wall 22. A body recess 31, the body recess 31 comprising a recess surface 16, may be formed on the recess wall 26, so that the recess wall 26 and recess surface 16 may be depressed into the body 11 below the first base wall 23 and the second base wall 24. A body projection 32 may be coupled to the recess wall 26 and/or to the second base wall 24, and the body projection 32 may extend over a portion of the body recess 31.

In some embodiments, the tool 100 may comprise a body 11 having a wedge surface 12, a first base surface 13, a second base surface 14, and a sidewall surface 15 that may each be generally planar in shape and that may be coupled together in a triangular prism shape, such as to form a wedge. In preferred embodiments, a first base surface 13 and a second base surface 14 may be generally parallel to each other and may be separated by a body recess 31 that may be depressed into the body 11. In further embodiments, a first base surface 13 and/or a second base surface 14 may be curved, such as concave cured or convex curved relative to a wedge surface 12. A body projection 32 may extend over a portion of the body recess 31. The body 11 may include one or more body apertures 41, 42, 43, 44, that may be sized and shaped to receive portions of valves or fittings that are typically manipulated by their rotation.

In preferred embodiments, the body 11 may comprise a wedge wall 22, a first base wall 23, a second base wall 24, and a sidewall 25. The wedge wall 22 may comprise or form one or more wedge surfaces 12, the first base wall 23 may form the first base surface 13, the second base wall 24 may form the second base surface 14, and the sidewall 25 may form the sidewall surface 15. In further preferred embodiments, the body 11 may comprise a wedge wall 22, a first base wall 23, a second base wall 24, and a sidewall 25 that may each be generally planar in shape and that may be coupled together in a triangular prism shape, such as to form a wedge.

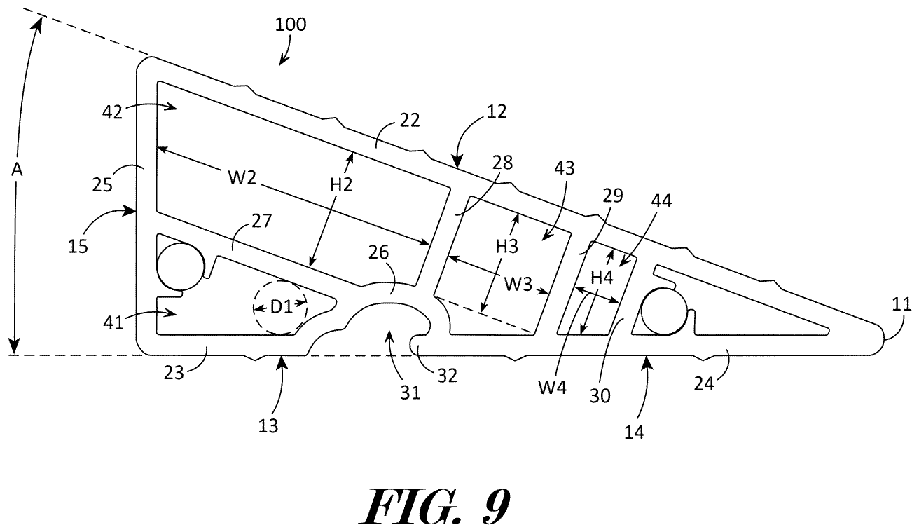

Generally, the body 11 may be generally configured with a wedge shape, e.g. having a triangular cross section and generally comprising a polyhedron defined by two triangles and three trapezoid faces. In some embodiments, the body 11 may have a wedge wall 22 that may have a wedge surface 12 that may be substantially planar in shape, a first base wall 23 that may have a first base surface 13 that may be substantially planar in shape, a second base wall 24 that may have a second base surface 14 that may be substantially planar in shape, and a sidewall 25 that may have a sidewall surface 15 that may be substantially planar in shape. Optionally, a first base wall 23 may be coupled to a second base wall 24 (likewise a first base surface 13 may be coupled to a second base surface 14) to form a unitary wall into which a body recess 31 may be formed. Preferably, a first base wall 23 may be separated from a second base wall 24 by a recess wall 26 of a body recess 31. Preferably, a first base surface 13 may be separated from a second base surface 14 by a body recess 31. Preferably, and as perhaps best shown in FIG. 9, a first base surface 13 may be substantially parallel (plus or minus 10 degrees) to a second base surface 14 (shown by the two substantially parallel dashed lines proximate to the first base surface 13 and second base surface 14 in FIG. 9). In preferred embodiments, the body 11 may comprise a wedge surface 12, a first base surface 13, a second base surface 14, and a sidewall surface 15 that may each be substantially planar in shape, and the wedge surface 12, the first base surface 13, the second base surface 14, and the sidewall surface 15 may form a wedge shape.

In some embodiments, the first base surface 13 may be coupled to the sidewall surface 15 so that they are angled between 70 and 110 degrees, and more preferably approximately 90 degrees, relative to each other. In some embodiments, the second base surface 14 may be coupled to the wedge surface 12 so that they are angled between 15 and 45 degrees, and more preferably approximately 20 degrees, relative to each other as shown with angle A in FIG. 9. In preferred embodiments, a wedge surface 12 and a first base surface 13 may be substantially planar in shape, and the first base surface 13 and the wedge surface 12 may be angled approximately between 20 and 40 degrees relative to each other as shown with angle A in FIG. 9. In further preferred embodiments, a wedge surface 12 and a second base surface 14 may be substantially planar in shape, and the second base surface 14 and the wedge surface 12 may be angled approximately between 20 and 40 degrees relative to each other. In some embodiments, the sidewall surface 15 may be coupled to the wedge surface 12 so that they are angled between 45 and 75 degrees, and more preferably approximately 70 degrees, relative to each other. In preferred embodiments, the body 11 may be configured with a wedge shape of a right triangle and has two faces (wedge surface 12 and first base surface 13 and/or second base surface 14) at an acute angle (approximately between 20 and 40 degrees) to each other and a third (sidewall surface 15) at a right angle to one of the first faces.

In some embodiments, the body 11 may comprise one or more wall ridges 51 which can capture progress as the tool 100 used is during forcible entry or when it is used with a chainsaw, assist in stacking multiple tools 100 together, or other uses. Preferably, one or more of the wedge surface 12, first base surface 13, and second base surface 14 may comprise one or more wall ridges 51. A wall ridge 51 may comprise a protrusion that may extend above the respective wedge surface 12, first base surface 13, or second base surface 14 that it may be coupled to. In preferred embodiments, a wedge wall 22 may comprise one or more wall ridges 51 that may extend above or away from the wedge surface 12. In preferred embodiments, a first base wall 23 may comprise one or more wall ridges 51 that may extend above or away from the first base surface 13. In preferred embodiments, a second base wall 24 may comprise one or more wall ridges 51 that may extend above or away from the second base surface 24.

A wall ridge 51 may be configured in any size and shape. In preferred embodiments, a wall ridge 51 may be configured in a generally elongated prism shape that may extend across a wedge surface 12, first base surface 13, or second base surface 14. Preferably, each wall ridge 51 may be elongated and oriented generally parallel to the other wall ridges 51. Generally, wall ridges 51 may facilitate stacking of two or more tools 100 as shown in the example of FIG. 6 with one or more wall ridges 51 of a first tool 100 may contact one or more wall ridges 51 of a second tool 100 to resist movement of the two tools 100 relative to each other. In further embodiments, wall ridges 51 may comprise any type of surface texturing or protrusions which may be used to prevent two tools from sliding across or away from each other.

The body 11 may include a body recess 31 that may be depressed into the body 11 such that the body recess 31 may extend below a first base surface 13 and a second base surface 14. In preferred embodiments, the body 11 may comprise a recess wall 26 that may be coupled to the first base wall 23 and to one or both of the second base wall 24 and body projection 32, and the recess wall 26 may form a recess surface 16 that may extend between the first base surface 13 and the body projection 32. In further embodiments, a recess surface 16 may be coupled to the first base surface 13 and to the body projection 32. A body recess 31 may be configured in any size and shape. Preferably, body recess 31 may extend across the body 11 to separate the second base wall 24 and body projection 32 from the first base wall 23.

Preferably, the recess wall 26 may comprise a recess ridge 33 which may form a portion of the recess surface 16 that extends towards the body projection 32. Optionally, portions of the recess surface 16 that are on opposite sides of the recess ridge 33 may be depressed below the recess ridge 33 and/or may have different surface contours from each other. For example, a portion of the recess surface 16 closest to the second base surface 14 may comprise a curved planar shape that may be relatively smaller in surface area and/or depth while a portion of the recess surface 16 on the opposite side of the recess ridge 33 and closest to the first base surface 13 may comprise a curved planar shape that may be relatively larger in surface area and/or depth.

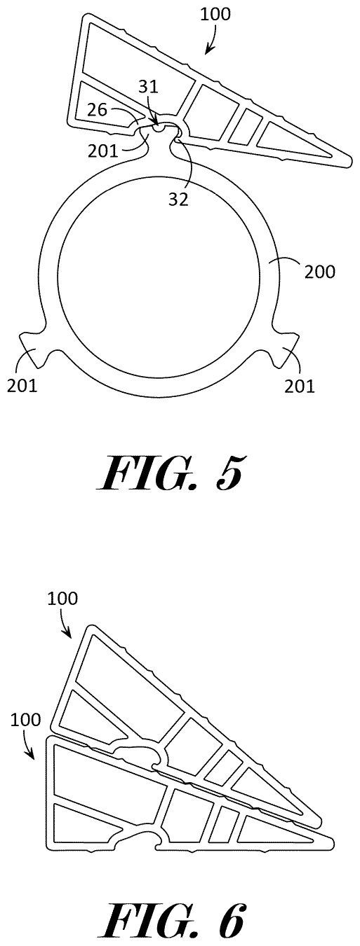

In some embodiments, the body 11 may comprise a body projection 32 that may be coupled to the recess wall 26 and its recess surface 16. In further embodiments, the body 11 may comprise a body projection 32 that may be coupled to the second base wall 24 and its second base surface 14. Preferably, the body projection 32 may extend over a portion of the body recess 31 towards the first base wall 23 and/or away from the second base wall 24. A body projection 32 and body recess 31 may allow the tool 100 to function as a spanner wrench for gripping and turning the lugs 201 of hose couplings 200 by applying a moment to the lug 201 of the coupling 200 as shown in FIG. 5, thus replacing the firefighter's need for a traditional spanner wrench. The body projection 32 and body recess 31 may allow the tool 100 to function as a spanner wrench for gripping and turning many different types and styles of lugs 201 and projections that are found on many different types and styles of hose couplings 200 lugs.

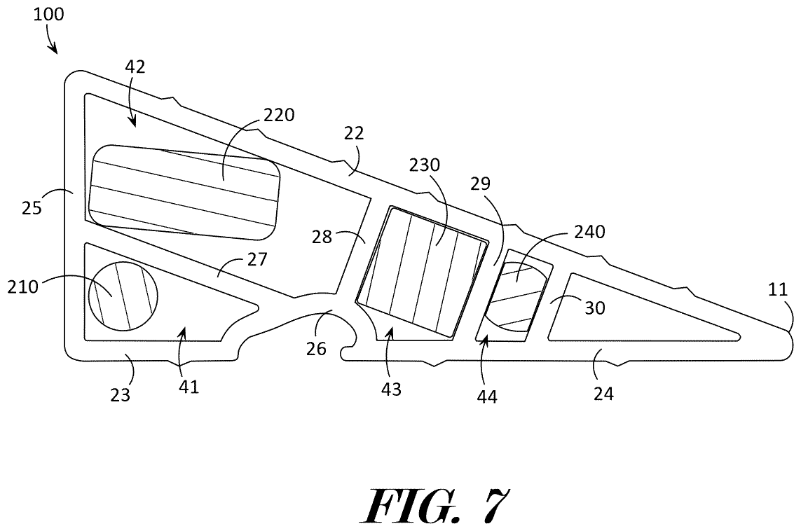

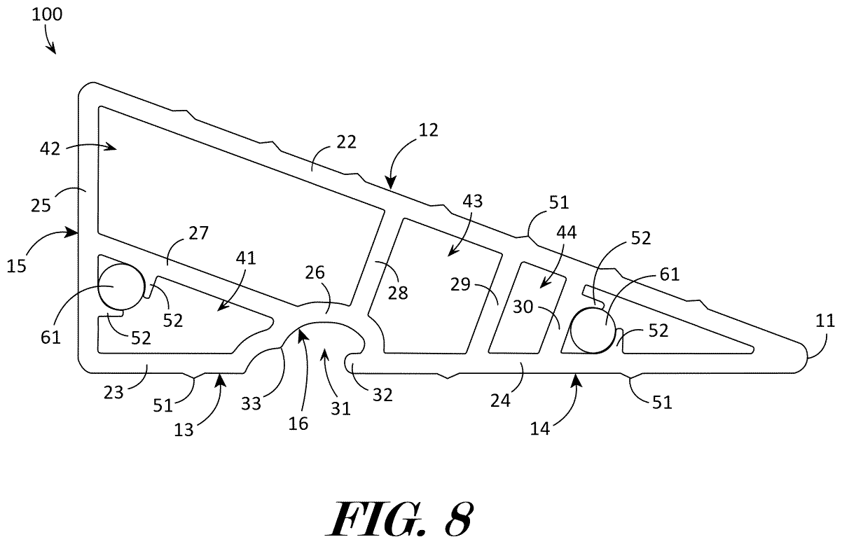

The body 10 may include one or more apertures 41, 42, 43, 44, that may be sized and shaped to receive portions of valves or fittings as shown in FIG. 7 that are typically manipulated by their rotation. In some embodiments, the one or more apertures 41, 42, 43, 44, may be formed in the body 11 between two or more of the wedge wall 22, first base wall 23, second base wall 24, sidewall 25, recess wall 26, and interior walls 27, 28, 29, 30. The body 11 of the tool 100 may include a lattice structure formed by interior walls 27, 28, 29, 30, between the wedge wall 22, first base wall 23, second base wall 24, sidewall 25, and/or recess wall 26 which may provide a plurality of apertures 41, 42, 43, 44, and give the tool 100 strength for forcible entry operations. Apertures 41, 42, 43, 44, may be configured in any size and shape. Optionally, one or more apertures 41, 42, 43, 44, may extend fully or partially through the body 11.

In some embodiments, the tool 100 may comprise a first body aperture 41 having diameter dimension D1 (FIG. 9) that may be formed anywhere in the body 11, such as between a first interior wall 27, the sidewall 25, the first base wall 23, and optionally the recess wall 26. Preferably, a first body aperture 41 may be configured to accept a generally cylindrical pin 210 of common pin-lug hose couplings. Pin-lug hose couplings are an economical and convenient coupling set for light duty liquid suction and discharge applications, and ship-board firefighting. A seal is obtained when the female swivel, typically comprising two opposingly positioned cylindrical pins 210, is threaded completely onto the male, seating at the gasket. Once a cylindrical pin 210, typically having a circular cross section, is inserted in the first body aperture 41, a user may manipulate the tool 100 to increase leverage and facilitate moving the cylindrical pin 210 of the pin-lug hose coupling when engaging and disengaging the pin-lug hose coupling.

In preferred embodiments, a first body aperture 41 may have dimensions (shown by diameter dimension D1 in FIG. 9) configured to accept a generally cylindrical pin 210 of a pin-lug hose coupling or the like having a diameter of approximately 0.415 inches. In alternative embodiments, a first body aperture 41 may have dimensions configured to accept a pin 210 of a pin-lug coupling or the like having a diameter of between approximately 0.215 inches and 0.615 inches.

In some embodiments, the tool 100 may comprise a second body aperture 42 that may be formed anywhere in the body 11, such as between a first interior wall 27, the sidewall 25, the wedge wall 22, and a second interior wall 28. In preferred embodiments, a second body aperture 42 may have dimensions configured to accept one or more sizes of gas (e.g., propane, natural gas, etc.) shut off valve stems 220, such as those used to supply buildings and equipment with gas (e.g., propane, natural gas, etc.). Once a gas shut off valve stem 220, typically having a rectangular cross section, is inserted in the second body aperture 42, a user may manipulate the tool 100 to increase leverage and facilitate moving the gas shut off valve stem 220 in order to engage and disengage gas flow through the valve that the gas shut off valve stem 220 is governing. In further embodiments, a second body aperture 42 may have dimensions configured to enable it to function as a carabiner attachment point to act as an emergency escape anchor.

In preferred embodiments, a second body aperture 42 may have a height dimension H2 (distance between the first interior wall 27 and wedge wall 22 as shown in FIG. 9) of approximately 0.650 inches. In further embodiments, a second body aperture 42 may have a height dimension H2 of between approximately 0.30 inches and 0.80 inches. In preferred embodiments, a second body aperture 42 may have a width dimension W2 (distance between the sidewall 25 and second interior wall 28 as shown in FIG. 9) of at least approximately 1.040 inches. In further embodiments, a second body aperture 42 may have a width dimension W2 of between approximately 0.80 inches and 1.20 inches. In alternative embodiments, a second body aperture 42 may have a height dimension H2 of between approximately 0.30 inches and 0.80 inches and a width dimension W2 of between approximately 0.80 inches and 1.20 inches.

In some embodiments, the tool 100 may comprise a third body aperture 43 that may be formed anywhere in the body 11, such as between a second interior wall 28, a third interior wall 29, the wedge wall 22, recess wall 26, and optionally the second base wall 24. In preferred embodiments, a third body aperture 43 may have dimensions configured to accept one or more sizes of standpipe water valve stems 230. Fire hose angle valves (sometimes called angle hose valves) attach to standpipe systems and their standpipe water valves and provide firefighters with a connection to water from inside the building. They eradicate the need for lengthy hose lays within tall or otherwise large buildings. Once a standpipe water valve stem 230, typically having a square rectangular cross section, is inserted in the third body aperture 43, a user may manipulate the tool 100 to increase leverage and facilitate moving the standpipe water valve stem 230 in order to engage and disengage water flow through the standpipe water valve that the standpipe water valve stem 230 is governing. This novel functionality of being able to engage a standpipe water valve stem 230 is invaluable in the sometimes-encountered first responder scenario in which the normally-provided handwheel is missing from the standpipe valve stem (as is common in older buildings or ones prone to vandalism).

In preferred embodiments, a third body aperture 43 may have a width dimension W3 (distance between the second interior wall 28 and third interior wall 29 as shown in FIG. 9) of approximately 0.563 inches. In further embodiments, a third body aperture 43 may have a width dimension W3 of between approximately 0.4 inches and 0.70 inches. In preferred embodiments, a third body aperture 43 may have a H3 height dimension (minimum distance between the recess wall 26 and wedge wall 22 as shown in FIG. 9) of approximately 0.563 inches. In further embodiments, a third body aperture 43 may have a minimum height dimension H3 of between approximately 0.4 inches and 0.70 inches (minimum height dimension H3 defined by the dimension in which width dimension W3 is at least between approximately 0.4 inches and 0.70 inches as shown with dashed line in third body aperture 43 in FIG. 9). In alternative embodiments, a third body aperture 43 may have a width dimension W3 of between approximately 0.4 inches and 0.70 inches and a height dimension H3 of between approximately 0.4 inches and 0.70 inches.

In some embodiments, the tool 100 may comprise a fourth body aperture 44 that may be formed anywhere in the body 11, such as between the third interior wall 29, a fourth interior wall 30, the wedge wall 22, and the second base wall 24. In preferred embodiments, a fourth body aperture 44 may have dimensions configured to accept an oxygen cylinder valve stem 240. An oxygen cylinder valve stem 240 is the piece of a valve that allows gas to be filled into or emptied from a compressed gas cylinder. Once an oxygen cylinder valve stem 240, commonly having a generally stadium shape (two-dimensional geometric shape constructed of a rectangle with semicircles at a pair of opposite sides) cross section, is inserted in the fourth body aperture 44, a user may manipulate the tool 100 to increase leverage and facilitate moving the oxygen cylinder valve stem 240 in order to engage and disengage oxygen flow through the valve that the oxygen cylinder valve stem 240 is governing.

In preferred embodiments, a fourth body aperture 44 may have a height dimension H4 (minimum distance between the second base wall 24 and wedge wall 22 as shown in FIG. 9) of approximately 0.312 inches. In further embodiments, a fourth body aperture 44 may have a height dimension H4 of between approximately 0.25 inches and 0.35 inches. In preferred embodiments, a fourth body aperture 44 may have a width dimension W4 (distance between the third interior wall 29 and the fourth interior wall 30 as shown in FIG. 9) of at least approximately 0.262 inches. In further embodiments, a fourth body aperture 44 may have a width dimension W4 of between approximately 0.20 inches and 0.30 inches. In alternative embodiments, a fourth body aperture 44 may have a width dimension W4 of between approximately 0.25 inches and 0.35 inches and a height dimension H4 of between approximately 0.25 inches and 0.35 inches.

Turning now to FIG. 8, in some embodiments, the tool 100 may comprise one or more magnets 61 that may be coupled to one or more locations on the body 11. In preferred embodiments, the tool 100 may comprise a first magnet 61 that may be coupled in the first body aperture 41, such as to the sidewall 25 and first interior wall 27, and a second magnet 61 that may be coupled distally to the first magnet 61, such as proximate to the junction of the wedge wall 22 and second base wall 24. It should be understood that the tool 100 may comprise any number of magnets 61 that may be coupled anywhere on the tool 100. For example, the tool 100 may comprise four magnets 61: two magnets 61 that may be coupled in the first body aperture 41 on opposite sides of the tool 100; and two magnets 61 that may be coupled proximate to a junction of the wedge wall 22 and second base wall 24 on opposite sides of the tool 100 so that both sides of the tool 100 may be magnetically adhered to a ferrous or magnetic object.

In some embodiments, the tool 100 may comprise one or more magnet bosses or retaining ridges 52 which may be used to couple a magnet 61 to a desired location on the body 11. Retaining ridges 52 may comprise projections of any size and shape that may be positioned so that a magnet 61 may preferably be wedged between two retaining ridges 52 and a junction of two walls 22, 23, 24, 25, 26, 17, 28, 29, 30. For example, a first magnet 61 that may be coupled to the body 11 within the first body aperture 41 by being press-fit between the junction of the sidewall 25 and first interior wall 27, a retaining ridge 52 positioned on the sidewall 25, and a retaining ridge 52 positioned on the first interior wall 27. As another example, a second magnet 61 that may be coupled to the body 11 proximate to the junction of the fourth interior wall 30 and second base wall 24 by being press-fit between the junction of the fourth interior wall 30 and second base wall 24, a retaining ridge 52 positioned on the fourth interior wall 30, and a retaining ridge 52 positioned on the second base wall 24. In further embodiments, a magnet 61 may be coupled to the body 11 with any other suitable coupling method or device.

A magnet 61 may be made from or may comprise a magnetic material, such as ferrite, ferromagnetic metal, ferric oxide, manganese-zinc ferrite, nickel-zinc ferrite, strontium ferrite, cobalt ferrite, barium ferrite, alnico, iron-silicon magnet alloy, ferritic steel and ferritic stainless steel, chromium-cobalt-iron alloy, iron-cobalt alloy, silver-manganese-aluminium alloy, manganese bismuthide alloy, platinum-cobalt alloy, chromium-manganese antimonide alloy, sintered barium ferrite, oxide-coated iron-cobalt particles, nickel-iron alloy, samarium-cobalt alloy, cesium-cobalt alloy, neodymium-iron-boron alloy, or any other suitable magnetic material, that is capable of magnetically adhering to another magnetic material through the principle of magnetism.

In preferred embodiments, the body 11 of the tool 100 may be made from an aluminum alloy material using an aluminum extrusion in which the aluminum alloy material is forced through a die with the cross-sectional profile of the body 11. In further embodiments, the body 11 of the tool 100 may be made from or may comprise any other durable and preferably fire-resistant materials, such as stainless steel, other metals and metal alloys, etc., and may be formed using any suitable manufacturing technique.

While some exemplary shapes and sizes have been provided for elements of the tool 100, it should be understood to one of ordinary skill in the art that the body 11, and any other element described herein may be configured in a plurality of sizes and shapes including “T” shaped, “X” shaped, square shaped, rectangular shaped, cylinder shaped, cuboid shaped, hexagonal prism shaped, triangular prism shaped, or any other geometric or non-geometric shape, including combinations of shapes. It is not intended herein to mention all the possible alternatives, equivalent forms or ramifications of the invention. It is understood that the terms and proposed shapes used herein are merely descriptive, rather than limiting, and that various changes, such as to size and shape, may be made without departing from the spirit or scope of the invention.

Additionally, while some materials have been provided, in other embodiments, the elements that comprise the tool 100 may be made from or may comprise durable materials such as aluminum, steel, other metals and metal alloys, wood, hard rubbers, hard plastics, fiber reinforced plastics, carbon fiber, fiberglass, resins, polymers or any other suitable materials including combinations of materials. Additionally, one or more elements may be made from or may comprise durable and slightly flexible materials such as soft plastics, silicone, soft rubbers, or any other suitable materials including combinations of materials. In some embodiments, one or more of the elements that comprise the tool 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the tool 100 may be coupled or removably connected by being press-fit or snap-fit together, by one or more fasteners such as magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, a slide-to-lock type connection method or any other suitable temporary connection method as one reasonably skilled in the art could envision to serve the same function. In further embodiments, one or more of the elements that comprise the tool 100 may be coupled by being one of connected to and integrally formed with another element of the tool 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A multi-purpose wedge tool, the tool comprising:
a body having a wedge wall, a sidewall, a recess wall, a first base wall, and a second base wall, wherein the first base wall is coupled to the recess wall and to the sidewall, wherein the wedge wall is coupled to the sidewall and to the second base wall, and wherein the recess wall is also coupled to the second base wall;
a wedge surface formed on the wedge wall;
a body recess, wherein the body recess comprises a recess surface formed on the recess wall, wherein the recess surface is depressed into the body below the first base wall and the second base wall; and
a body projection coupled to the recess wall, wherein the body projection extends over a portion of the body recess.

2. The tool of claim 1, wherein the body projection is coupled to the second base wall and to the recess wall.

3. The tool of claim 2, wherein the body projection extends towards the first base wall.

4. The tool of claim 1, wherein the wedge wall has a wedge surface that is substantially planar in shape, wherein the first base wall has a first base surface that is substantially planar in shape, wherein the second base wall has a second base surface that is substantially planar in shape, and wherein the sidewall has a sidewall surface that is substantially planar in shape.

5. The tool of claim 4, wherein the first base surface is substantially parallel to the second base surface.

6. The tool of claim 4, wherein the wedge surface, the first base surface, the second base surface, and the sidewall surface form a wedge shape.

7. The tool of claim 4, wherein the first base surface and the wedge surface are angled approximately between 20 and 40 degrees relative to each other.

8. The tool of claim 4, wherein the second base surface and the wedge surface are angled approximately between 20 and 40 degrees relative to each other.

9. The tool of claim 4, wherein the wedge wall comprises a wall ridge that extends above the wedge surface.

10. The tool of claim 4, wherein the first base wall comprises a wall ridge that extends above the first base surface.

11. The tool of claim 4, wherein the second base wall comprises a wall ridge that extends above the second base surface.

12. The tool of claim 1, wherein the recess wall comprises a recess ridge that extends towards the body projection.

13. The device of claim 1, wherein the recess surface is coupled to the first base surface and to the body projection.

14. The tool of claim 1, wherein the body recess separates the first base surface and the second base surface.

15. The tool of claim 1, wherein the first base wall and the second base wall are separated from each other by the recess wall.

16. The tool of claim 1, further comprising a magnet coupled to the body.

17. The tool of claim 1, wherein the body includes a first body aperture configured to accept a cylindrical pin having a diameter of between approximately 0.215 inches and 0.615 inches.

18. The tool of claim 1, wherein the body comprises a second body aperture sized to manipulate a gas shutoff valve by the second body aperture having a height dimension of between approximately 0.30 inches and 0.80 inches and a width dimension of between approximately 0.80 inches and 1.20 inches.

19. The tool of claim 1, wherein the body comprises a third body aperture sized to manipulate standpipe valves by the third body aperture having a width dimension of between approximately 0.4 inches and 0.70 inches and a height dimension of between approximately 0.4 inches and 0.70 inches.

20. The tool of claim 1, wherein the body includes a fourth body aperture sized to manipulate an oxygen cylinder stem by the fourth body aperture having a width dimension of between approximately 0.25 inches and 0.35 inches and a height dimension of between approximately 0.25 inches and 0.35 inches.
